(19) United States
(12) Patent Application Publication
(10) Pub. No.: US 2018/0372599 A1
(43) Pub. Date: Dec. 27, 2018

(54) SYSTEM AND METHOD FOR PULSED EVAPORATIVE CONDENSATION EXTRACTION FOR SAMPLE PREPARATION

(71) Applicant: Entech Instruments Inc., Simi Valley, CA (US)

(72) Inventor: Daniel B. CARDIN, Simi Valley, CA (US)

(21) Appl. No.: 16/013,314

(22) Filed: Jun. 20, 2018

Related U.S. Application Data
(60) Provisional application No. 62/522,914, filed on Jun. 21, 2017.

(51) Int. Cl. G01N 1/40; G01N 1/34

(52) U.S. Cl. CPC G01N 1/405; G01N 2001/4027; G01N 1/34

(57) ABSTRACT

Trace Volatile and Semi-Volatile compounds within a sample can be extracted and concentrated on an sorbent in the headspace of a closed sample vial by alternating the temperature of the sample repeatedly from hot to cold. As the sample heats, mass transport can occur from the sample into the headspace that can increase the speed of ejection of one or more chemicals from the sample into the headspace where they can be collected on the sorbent, for example. In some examples, re-cooling and then re-heating the sample can allow faster transport to continue until significant transport has occurred of one or more target compounds from the sample to the adsorbent, leaving behind the non-volatile chemicals and most of the liquid matrix that would otherwise interfere with the chemical analysis device. The pulsed heating and cooling can be performed under vacuum to increase the speed of the extraction process.

### CROSS-REFERENCE TO RELATED APPLICATIONS

This application claims benefit of U.S. Provisional Patent Application No. 62/522,914, filed Jun. 21, 2017, which is hereby incorporated by reference in its entirety.

### FIELD OF THE DISCLOSURE

This relates to a system and method for preparing a sample for chemical analysis and, in particular, a system and method for extracting target compounds from a liquid or aqueous sample using a sorbent in the headspace of a sample vial that is held under vacuum to increase the rate of transfer of compounds into the headspace, combined with heating and cooling the sample, referred to here as pulsed evaporative condensation.

### BACKGROUND

Many liquid samples to be analyzed by gas chromatography and/or gas chromatography-mass spectrometry contain non-volatile compounds that cannot be injected into the chemical analysis device and/or must be concentrated to remove or reduce bulk matrix constituents prior to analysis in order to reach required detection limits. Solvent extraction can be used in sample preparation, however, many non-volatile chemicals also dissolve in solvent, thereby requiring a labor intensive cleanup process before the sample can be injected into the chemical analysis device, for example. In addition, solvents when expanded into the gas phase during GCMS analysis can cause system contamination when injecting more than 1 microliter of solvent, severely limiting the fraction of the extract that can be analyzed, and therefore the sensitivity of the technique. Solvent extraction can be time-consuming, can require substantial manual labor in the lab which can limit productivity and efficiency, and can take a lot of laboratory space adding to the cost of analysis. Finally, most extraction solvents pose health risks, both for analysts directly working with them and for communities surrounding labs that are expelling solvents out vacuum hoods into the environment.

In some examples, headspace analysis, such as purge and trap techniques, can be performed to avoid the use of solvents while extracting volatile compounds. Purge and trap techniques include purging a gas through a liquid sample or the headspace of a sample held within a sample vial and trapping the sample outside of the sample vial, for example. In some examples, however, headspace techniques such as purge and trap, SPME, ARROW, DHS, and Loop Injection may fail to recover the low volatility compounds that can be extracted using solvents. Therefore, there exists a need for a sample extraction system and technique that is able to recover a wide range of semi-volatile and volatile compounds that does not require the use of solvents.

### SUMMARY

This relates to a system and method for preparing a sample for chemical analysis and, in particular, a system and method for extracting target compounds from a liquid or aqueous sample using a sorbent in the headspace of a sample vial that is held under vacuum to increase the rate of transfer of compounds into the headspace, combined with heating and cooling the sample, referred to here as pulsed evaporative condensation. In some examples, a sample extraction system can include a convection oven, one or more additional heating and/or cooling elements, one or more sample vials holding liquid or aqueous sample, and a sorbent container in each of the sample vials. After optionally pulling a vacuum in the sample vials, each sample vial can form a closed system, for example. In some examples, the one or more additional heating and/or cooling elements can repeatedly heat and cool the liquid sample to cause one or more sample compounds to repeatedly evaporate and condense. When the sample is heated, some of the evaporated compounds can be captured by the sorbent in the sorbent container, for example. In some examples, when the sample is cooled, the sample compounds in the headspace of the sample vial can re-condense into the liquid or aqueous sample. The recooling of the sample can reestablish the vacuum in the vial if a vacuum was exterted initially. Repeated evaporation and condensation can allow the system to more completely transfer target compounds from the liquid matrix to the sorbent held in the headspace, resulting in improved recovery rates, shorter extraction times, and consistent results across multiple sample vials containing the same sample.

### BRIEF DESCRIPTION OF THE DRAWINGS

FIG. 1 illustrates an exemplary process for extracting, desorbing, and analyzing a sample according to examples of the disclosure.

FIG. 2 illustrates an exemplary sorbent container according to examples of the disclosure.

FIGS. 3A-3B illustrate a sample preparation system according to examples of the disclosure.

FIG. 4 illustrates an exemplary process for extracting a sample for analysis according to examples of the disclosure.

FIG. 5A illustrates an exemplary chemical analysis device, an exemplary sorbent container, and detector for conducting chemical analysis according to examples of the disclosure.

FIG. 5B illustrates an exemplary process for performing a chemical analysis procedure using desorption device, sorbent container inserted into desorption device, chemical analysis device, and detector device according to examples of the disclosure.

### DETAILED DESCRIPTION

In the following description, reference is made to the accompanying drawings which form a part hereof, and in which it is shown by way of illustration specific examples that can be practiced. It is to be understood that other examples can be used and structural changes can be made without departing from the scope of the examples of the disclosure.

Liquid samples can be prepared for chemical analysis in a variety of ways, as described above. For example, solvent extraction can be used to prepare a sample with semi-volatile target compounds. These and other methods of sample preparation, however, have problems that the present disclosure seeks to reduce and/or eliminate.

For example, many non-volatile chemicals (e.g., waxes, heavy mineral oils, PPM moisture carrying salts, etc.) can be dissolved by solvents used to perform solvent extraction, thereby requiring labor intensive cleanup prior to chemical analysis. When non-volatile compounds are extracted by the solvent and injected into the chemical analysis device, the chemical analysis device must be cleaned and/or one or more contaminated components of the chemical analysis device must be replaced, for example. In some examples, solvent extraction can extract heavy non-volatile compounds that are thermally unstable and create new compounds or artifacts when heated for injection into a chemical analysis device. These artifacts may not have been present in the original sample, which can reduce the accuracy of the chemical analysis process. In some examples, chemists cannot tell the difference between break down products and chemicals that were truly present in the original sample.

In view of the number of problems with solvent extraction, a general class of extraction techniques called headspace analysis can be used to recover target compounds from a sample in the VOC and SVOC range, for example. Headspace analysis, however, can fail to recover the entire range of low volatility compounds that can be recovered using solvents prior to chemical analysis (e.g., using GCMS), making it a poor replacement for solvent extraction in some examples, such for extracting SVOCs and other low-volatility target compounds.

Because of the shortcomings of solvent extraction and many headspace analysis techniques, there exists a need for an improved sample preparation technique and/or system. Systems and methods of sample preparation disclosed herein can address the above problems and offer further advantages, such as increased extraction efficiency and reduction in extraction time. Additionally, the disclosure can allow a true equilibrium to be achieved in the sample vial, which can provide greater reproducibility and accuracy in the chemical analysis while increasing the range of recoverable compounds, for example. In some examples, one or more non-volatile compounds in the original sample that could damage the chemical analysis device or thermally decompose to create artifacts, as discussed above, can be eliminated from the collected sample, thereby reducing or preventing contamination of the chemical analysis device and/or reducing or preventing reporting of artifact compounds in the analysis that in fact were not even in the original sample but were instead the result of an extraction technique which allowed new compounds to be created through thermal decomposition. Further, the range of temperatures that the sample can be exposed to during extraction can be varied depending on the thermal properties of the sample to avoid thermally stressing the sample.

This relates to a system and method for preparing a sample for chemical analysis and, in particular, a system and method for extracting target compounds from a liquid or aqueous sample using a sorbent in the headspace of a sample vial that is held under vacuum to increase the rate of transfer of compounds into the headspace, combined with heating and cooling the sample, referred to here as pulsed evaporative condensation. In some examples, a sample extraction system can include a convection oven, one or more additional heating and/or cooling elements, one or more sample vials holding liquid or aqueous sample, and a sorbent container in each of the sample vials. After optionally pulling a vacuum in the sample vials, each sample vial can form a closed system, for example. In some examples, the one or more additional heating and/or cooling elements can repeatedly heat and cool the liquid sample to cause one or more sample compounds to repeatedly evaporate and condense. When the sample is heated, some of the evaporated compounds can be captured by the sorbent in the sorbent container, for example. In some examples, when the sample is cooled, the sample compounds in the headspace of the sample vial can re-condense into the liquid or aqueous sample. The recooling of the sample can reestablish the vacuum in the vial if a vacuum was exterted initially. Repeated evaporation and condensation can allow the system to more completely transfer target compounds from the liquid matrix to the sorbent held in the headspace, resulting in improved recovery rates, shorter extraction times, and consistent results across multiple sample vials containing the same sample.

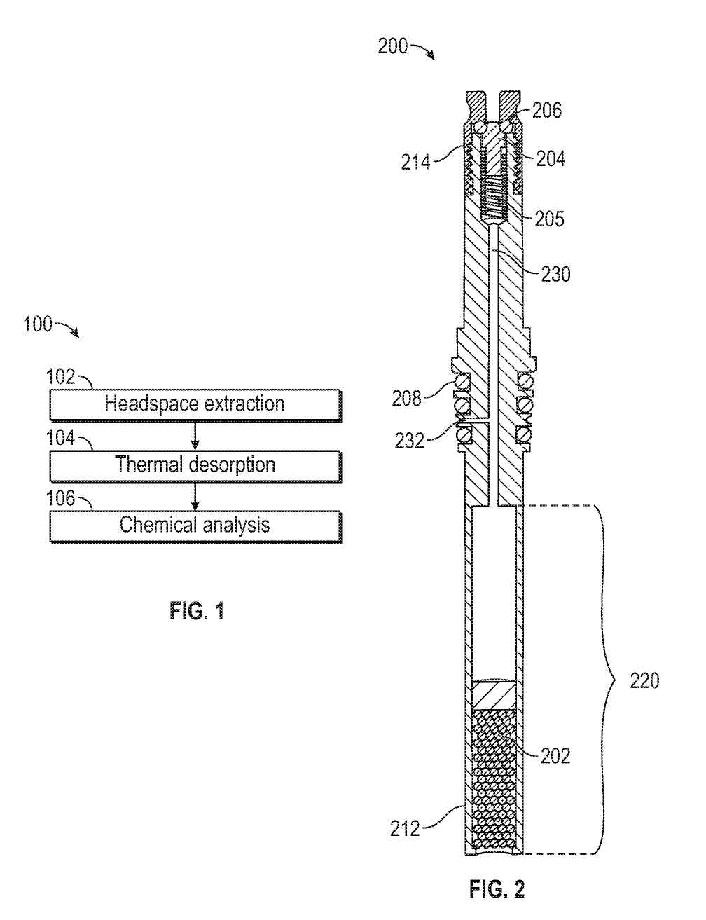

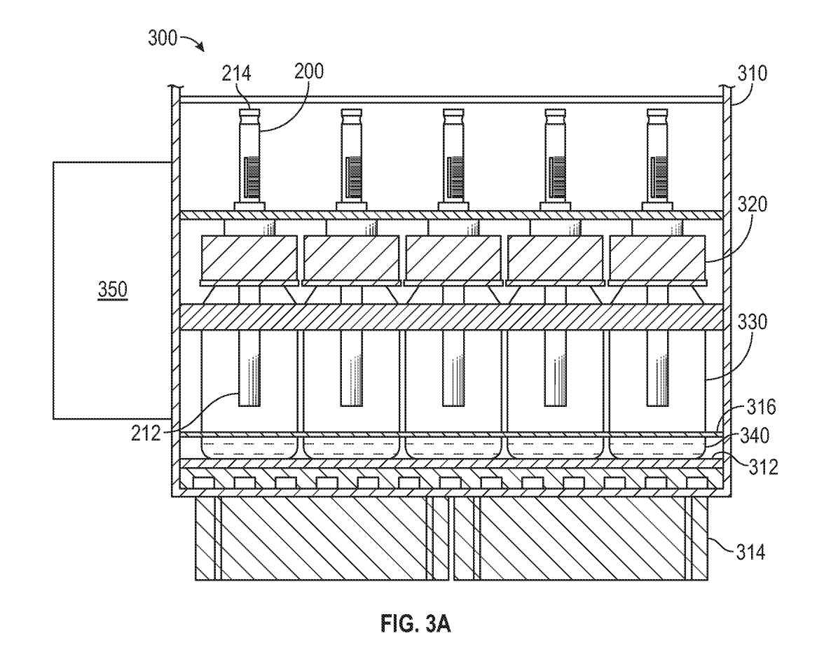

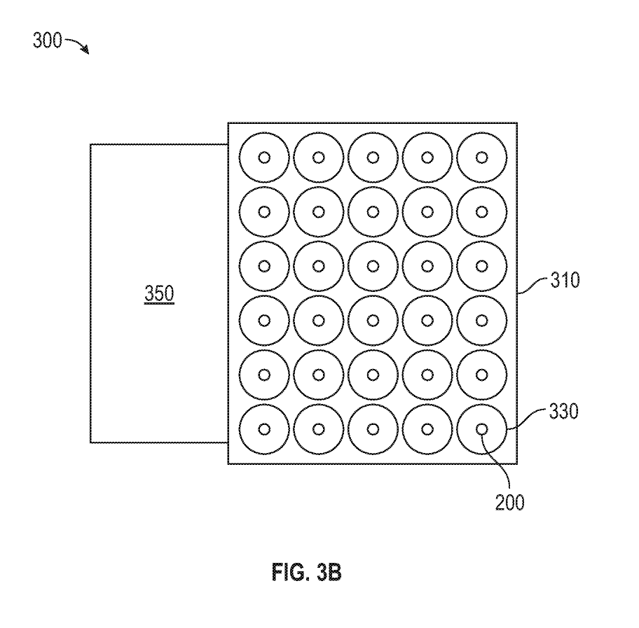

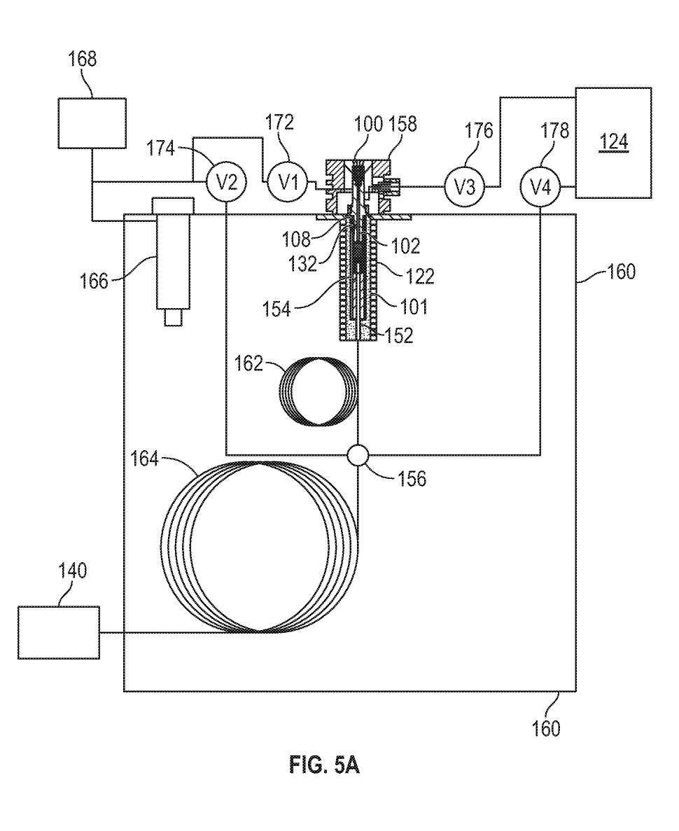

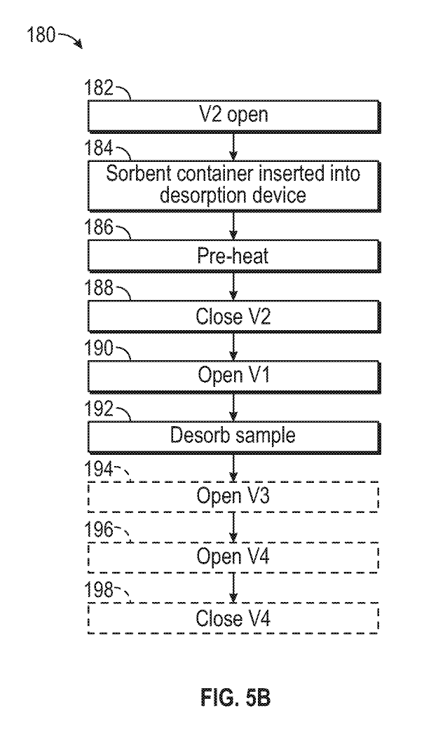

FIG. 1 illustrates an exemplary process 100 for extracting 102, desorbing 104, and analyzing 106 a sample according to examples of the disclosure. In some examples, headspace extraction 102 can be executed using a sorbent container 200, as will be described below with reference to FIG. 2, and a sample preparation system 300, as will be described below with reference to FIGS. 3A-3B. During headspace extraction 102, one or more compounds of interest can be extracted from a sample and collected in the sorbent of the sorbent container 200, for example. In some examples, the extracted sample can be thermally desorbed 104 using an arrangement described below with reference to FIGS. 5A-5B. During thermal desorption 104, the extracted sample can be desorbed from the sorbent of the sorbent container 200 for analysis. Chemical analysis 106 can be conducted, for example, using a GC, a GC-MS, a LC, an LCMS, or another suitable chemical analysis device. For LC or LCMS analysis, rather than performing thermal desorption 104, a small amount of solvent may be used to recover the extracted compounds for complete delivery of the extract into the LC or LCMS.

FIG. 2 illustrates an exemplary sorbent container 200 according to examples of the disclosure. In some examples, sorbent container 200 can retain, in the sorbent, one or more sample compounds for analysis (e.g., using the configuration illustrated below in FIG. 5). Other sorbent containers, such as 3.5″ thermal desorption tubes, are possible without departing from the scope of the disclosure. As an example, sorbent container 200 can have a diameter between 1/32 in. and ⅜ in. (e.g., the external or internal diameter of the sorbent container). In some examples, other dimensions are possible. Sorbent container 200 can comprise a tube-like structure, for example, that includes various channels and/or cavities as will be described below. In some examples, sorbent container 200 can be fabricated from stainless steel or another suitable material (e.g., a material that is substantially inert). All or part of the surface of sorbent container 200 can be coated with a chemical vapor deposition (CVD)-deposited ceramic to increase the inertness of the sorbent container 200, for example. Other coatings that similarly increase the inertness of the sorbent container 200 can similarly be used.

Sorbent container 200 can include lower cavity 220. In some examples, the lower cavity 220 can contain a sorbent 202, which can be, for example, an adsorbent or an absorbent. The sorbent can be Tenax TA, Tenax/Carboxen, a short piece of 0.53 mm ID porous layer open tubular (PLOT) column ranging in composition from polydimethylsiloxane (PDMS), PLOT Q, and/or Carboxen, or some other sorbent that can be chosen based on the sample(s) to be collected by the sorbent container 200, for example. As will be described below, in some examples, sorbent 202 can be selected to collect a sample for analysis. In some examples, the sorbent 202 can be located towards an extraction end 212 of the sorbent container 200. That is to say, sorbent 202 can be closer to the extraction end 212 of the sorbent container 200 than it is to a valve end 214 of the sample extraction device. In some examples, two or more sorbents with different strengths can be used to constitute the sorbent 202 to increase the range of recoverable compounds, where a weaker sorbent can be placed closer to the lower opening of lower cavity 220, followed by one or more stronger sorbents that may be placed further away from the opening. This arrangement of two or more sorbents can allow for collection and recovery during analysis of a wider boiling point range of compounds. Extraction end 212 of the sorbent container 200 can be open to the environment of the sorbent container such that the sample being collected can enter lower cavity 220, and can adsorb or absorb to sorbent 202, as will be described in more detail below. In some examples, lower cavity 220 can contain a material for which a thermal analysis is to be performed. In such examples, lower cavity 220 can be designed to be removed from the rest of container 200. In this way, lower cavity 220 can be filled, desorbed, and either refilled or disposed of after analysis.

At the valve end 214 of the sorbent container 200 (e.g., opposite extraction end 212 of the sorbent container 200), the sorbent container 200 can include a sealing plunger 204, a spring 205, and an internal seal 206, for example. The internal seal 206 can be a fluoroelastomer seal, a perfluoroelastomer seal, or any other suitable seal, for example. In some examples, sealing plunger 204 and internal seal 206 can selectively restrict fluid (e.g., gas, liquid, etc.) flow through internal channel 230 between sealing plunger 204/internal seal 206 and lower cavity 220/sorbent 202. For example, when sealing plunger 204 is pressed up against seal 206, fluid flow through sorbent container 200 can be restricted, and when sealing plunger 204 is moved away or otherwise separated from seal 206, fluid flow through sorbent container 200 may be unrestricted. In some examples, sealing plunger 204 can be tensioned via spring 205 against seal 206 such that in a default configuration, sealing plunger 204 can be pressed up against seal 206 and fluid flow through sorbent container 200 can be restricted. In some examples, spring 205 can be fabricated from a non-reactive material, such as 316 stainless steel coated with a ceramic material using a chemical vapor deposition (CVD) process. Fluid flow (e.g., air being drawn into a vacuum source or carrier fluid being allowed in by a pressurized container) through sorbent container 200 can be allowed by causing sealing plunger 204 to move away from seal 206 (e.g., via mechanical means such as a pin from above, or other means). For example, a vacuum source can be coupled to the sample extraction device 100 at the valve end 214 to open sealing plunger 204 and draw a vacuum through sealing plunger 204, an internal channel 230, and lower cavity 220. Additionally, in some examples, sealing plunger 204 can remain open (e.g., during continuous vacuum evacuation) to evaporate unwanted matrix, such as water or alcohol, from the sample through sorbent 202.

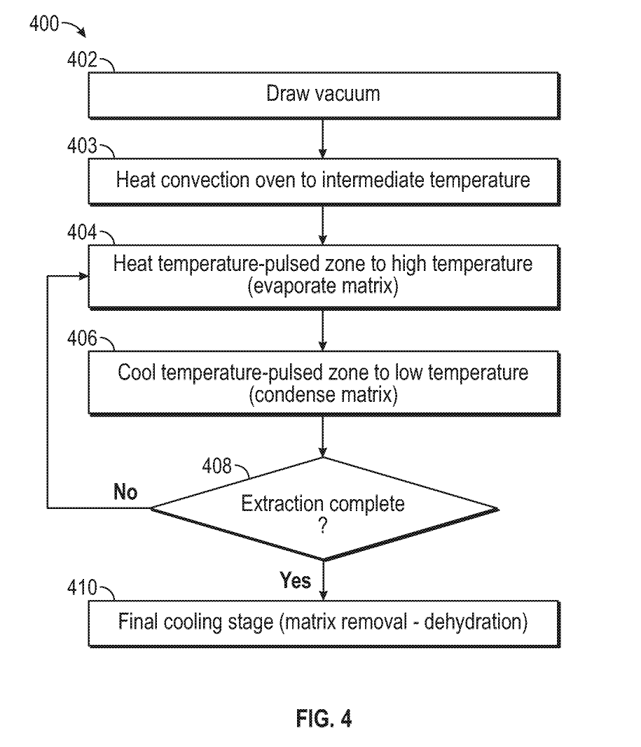

After a sample extraction process, which will be described in more detail below with reference to FIGS. 3A-4, the extracted compounds can be analyzed in a chemical analysis process, as will be described below with reference to FIGS. 5A-5B. In some examples, during the chemical analysis process, a carrier fluid can be introduced through sealing plunger 204, into internal channel 230 and lower cavity 220, and into chemical analysis device 506, allowing for rapid desorption of the sample from sorbent 202 into the chemical analysis device 506. Additionally or alternatively, in some examples, during the chemical analysis process, the carrier fluid can be introduced through desorption port 232 (e.g., instead of through sealing plunger 204), into internal channel 230 and lower cavity 220, and into chemical analysis device 506.

In some examples, desorption port 232 can be in fluid communication with lower cavity 220 and the outside of sorbent container 200. Preferably, the open end of desorption port 232 can be located between external seals 208 so that port 232 is closed when the sample extraction device 100 is sealed against another object (e.g., a desorption device or sample vial), for example. In some examples, ports at other locations on sorbent container 200 are possible.

The sorbent container 200 can further include one or more external seals 208, for example. The external seals 208 can be made of an elastomeric material and can be fluoroelastomer seals or perfluoroelastomer seals. In some examples, the external seals 208 can be Viton™ seals or other suitable seals. The external seals 208 can be located externally on sorbent container 200 between ends 212 and 214. The external seals 208 can include one or more gaskets or o-rings fitted around the outside of the sorbent container 200, for example. In some examples, the external seals 208 can be used to form a seal between sorbent container 200 and a desorption device (e.g., desorption device 104) into which sorbent container 200 can be inserted during a sample desorption process. A more detailed discussion of the sorbent container 200 can be found in U.S. patent application Ser. No. 15/450,236 entitled “VACUUM-ASSISTED SAMPLE EXTRACTION DEVICE AND METHOD” incorporated in its entirety herein for all purposes. Systems and methods for using the sorbent container 200 to extract a sample will be described below with reference to FIGS. 3A-4.

FIGS. 3A-3B illustrate a sample preparation system 300 according to examples of the disclosure. FIG. 3A illustrates a side view of the sample preparation system 300 and FIG. 3B illustrates a top view of the sample preparation system 300. In some examples, sample preparation system 300 includes one or more sorbent containers 200, a convection oven 310, a convection fan 350, one or more sample vials 330, heating and/or cooling element(s) 312, and one or more air flow fans 314.

In some examples, the sample vials 330 can include glass or deactivated glass. The sample vial 330 can have a volume in the range of 20 mL to 250 mL, for example. Optional lid assembly 320 can include a screw on cap, a lid, and an o-ring to create a seal between the lid and the top of the sample vial 330. After sample extraction is complete, the optional lid assembly 320 can be washed in deionized, organic free water, and heated in a lab oven before reuse to eliminate any residual contamination that could cause carryover. In some examples, optional lid assembly 320 is eliminated and the sorbent container 200 can be directly inserted into the sample vials 330, with the seals 208 of the sorbent container 200 acting to seal the sample vial 330 and the sorbent container 200, thereby creating a closed system.

In some examples, sample 340 inside sample vials 330 includes a liquid or aqueous sample having one or more volatile or semi-volatile target compounds (and in some examples, non-volatile compounds). In some examples, sample 340 can include foods, environmental samples such as water and soil, natural products, consumer products, and a large number of other materials. These types of samples and others may not be suitable for chemical analysis without undergoing an extraction process to isolate analyzer compatible compounds for analysis. Without undergoing extraction, these samples can damage or destroy a chemical analysis device and/or may include compounds that create thermal decomposition products that were not in the original sample, for example. In some examples, water and/or soil sample 340 can be collected and analyzed to determine the presence and concentration of herbicides, pesticides, fungicides, VOCs, SVOCs, PAHs, PCBs, CWAs, Endocrine Disruptors, and other contaminations. Clinical sample 340 including blood, urine, and breath condensate can be collected and analyzed to determine the presence and concentration of illicit drugs and disease markers, for example. In some examples, food and beverage sample 340 can be collected and analyzed to determine the presence and concentration of flavors and fragrances. Cosmetics and other consumer product sample 340 can be collected and analyzed to determine the presence and concentration of regulated contaminants at trace levels, for example. Other examples include analysis of sea water for trace components and use in a variety of forensic measurements.

In some examples, the extraction system 300 and associated method of use 400 (described in more detail below with reference to FIG. 4), can concentrate the compounds of interest of the sample 340 and/or remove bulk matrix constituents prior to analysis. In this way, interferences can be reduced or removed and required detection limits can be more readily met. Further, examples of the disclosure can protect the chemical analysis device from exposure to compounds that could cause damage and prevents the injection of compounds that create thermal decomposition products not in the original sample 340, as described above. The present disclosure can also reduce or remove water and/or ethanol from the sample prior to chemical analysis to prevent interferences in the chemical analyzer which would affect accuracy in the analytical results, for example.

Sorbent containers 200 can be the same as or similar to the sorbent containers 200 described above with reference to FIG. 2. In some examples, additional or alternative sorbent containers or collection devices can be used. Prior to extraction, the sorbent containers 200 can be placed in an isolation sleeve to avoid contaminating the sorbent prior to sample extraction, for example. As described above with reference to FIG. 2, sorbent containers 200 can include a valve end 214 and an extraction end 212. In some examples, sorbent containers 200 can be coupled to sample vials 330 such that once coupled, the valve end 214 of sorbent containers 200 can be outside of sample vials 330, and the extraction end 212 of sorbent containers 200 can be inside sample vials 330. Once the sorbent containers 200 are coupled to the sample vials 330 with, for example, optional lid assemblies 320 attached (e.g., sorbent container 200 can be inserted into an opening in the top of a sample vial 330, such as a hole in the optional lid assembly that creates a seal with the sorbent container 200 when the sorbent container 200 is inserted), or directly coupled to the opening of the sample vials (e.g., with seals 208 of the sorbent container 200 acting to seal the sample vials and sorbent containers) a vacuum can be pulled through the valve end 214 of the sorbent container 200 to create a vacuum in the sample vials 330, though in some examples the techniques of the disclosure can be performed without pulling a vacuum in the sample vials 330. In some examples, creating a vacuum within the sample vials 330 can increase transfer of compounds to gas phase for collection in the sorbent container 200 and/or also remove the initial gas in the vial.

Seals 208 of the sorbent container 200 and, in some examples, optional lid assemblies 320 can prevent leaks to or from the sample vials 330 during extraction, thereby creating a “closed system” within each of the sample vials 330 such that no mass is transferred into or out of the sample vial during the extraction process. Extraction end 212 of the sorbent containers 200 can be open to the headspace in the sample vials 330, but not in direct contact with the sample 340, allowing one or more compounds included in sample 340 to evaporate and enter the sorbent containers 200 and be trapped by a sorbent included in the sorbent containers, as described above with reference to FIG. 2. In some examples, other sorbent retention means, such as a sorbent-coated fiber, tube, or rod, can be used.

Convection oven 310 can accommodate a plurality of (e.g., about 30) sample vials 330 during the extraction process, as shown in FIG. 3B, for example. In some examples, convection oven 310 can include convection fan 350, for example. Convection fan 350 can include a heating and/or cooling element and a fan, for example. In some examples, the heating and/or cooling element of convection fan 350 can be used to regulate the temperature of the headspace of the sample vials 330 during sample extraction. The fan of the convection fan 350 can circulate the air in the convection oven to thereby convectively regulate the temperature of the headspace of the sample vials 330, for example. In some examples, the convection fan 350 can circulate air around the perimeter of the plurality of sample vials 330 held within the convection oven 310 and through the array of sample vials 330 to create an even temperature. The sample vials 330 can be retained in a tray that covers the top of the optional lid assemblies 320 that can lock the sample vials 330 into place during extraction so that a robot can remove the sorbent containers 200 from the sample vials 330 after extraction, for example. In some examples, the robot can store the sorbent containers 200 in isolation sleeves between extraction and analysis to prevent contamination. The isolation sleeves can be retained in a tray having a similar arrangement to the convection oven, for example. As an example, when the convection oven tray retains 30 sample vials 330 in a 5 by 6 array as shown in FIG. 3B, the isolation sleeve tray can also retain 30 sample vials 330 in a 5 by 6 array. Other numbers of sample vials 330 and array dimensions are possible.

In some examples, the bottom surface of the convection oven 310 can include one or more heating and/or cooling element(s) 312, such as one or more hot plates and/or one or more Peltier coolers. Other active heating and cooling elements are possible. Fans 314 can also be used to regulate the temperature of the bottom surface of the convection oven 310 (e.g., by cooling down a heating element or warming a cooling element 312). As shown in FIG. 3A, in some examples, the heating and/or cooling element(s) 312 can be placed within the system 300 such that they are closer to the sample 340 than they are to the headspace of the sample vials 330. In some examples, the sample vials 330 can be placed in the convection oven 310 such that the bottoms of the sample vials are in contact with heating and/or cooling element(s) 312, which can cause the heating and/or cooling elements to conductively regulate the temperature of the sample 340.

An insulating material 316 (e.g., an insulating foam having a thickness on the order of 0.03 to 0.3 inches) can be located closer to the bottom of the sample vials 330, and therefore closer to the sample 340, than it is to the top of the sample vials 330, for example, to separate the temperature zone heated by the convection fan 350 from the temperature zone heated by the heating and/or cooling element(s) 312. In this way, the system 300 can create two temperature zones with the sample 340 being exposed to colder temperatures during cooling phases and warmer temperatures during warming phases by the heating and/or cooling element(s) 312, for example. The two-temperature zone operation of the system 300 will be described in more detail below. One or more fans 314 can be positioned to cool a heating element of the heating and/or cooling element(s) 312, for example. The temperatures of the headspace of the sample vials 330 and the liquid samples 340 can be separately regulated by the convection fan 350 and the heating and/or cooling element(s) 312, respectively, to create even temperatures throughout each respective zone of the convection oven 310 so that each sample 340 is heated and cooled to substantially the same temperatures with substantially the same timing. In this way, the system 300 offers consistent extraction of one or more target compounds of the sample 340 across the plurality of sample vials 330.

In some examples, prior to heating and cooling the sample 340 as will be described below, a vacuum can be pulled in the sample vials 330, as mentioned above. The vacuum can be pulled such that the pressure of the headspace of the sample vials 330 is around 0.01 to 0.03 atmospheres, or approximately the pressure that can cause a liquid or aqueous sample to start boiling at a temperature around 25 degrees Celsius, for example. In some examples, the pressure in the sample vials 330 created by the vacuum source can be selected depending on the vapor pressure of major matrix components of the sample 340. Cooling the sample vials 330 can allow lower pressures to be achieved by lowering the vapor pressure of the matrix, for example. In some examples, the vacuum source can be applied to the sample vials 330 for a period of time in the range of 15 to 30 seconds.

Once the sample 340 is placed within the sample vials 330 and the sorbent container 200 is attached to the sample vials 330, optionally though optional lid assemblies 320, a vacuum can be pulled at the valve end 214 of the sorbent containers 200. When the sorbent containers 200 are attached to the sample vials 330, the seals 208 of the sorbent containers 200 and, in some examples the optional lid assemblies 320, form a seal to create a closed system in the sample vials 330. Pulling the vacuum can evacuate most of the headspace gas (e.g., air present in the sample vial 330 at the time the sample 340 was deposited in the sample vial) in the sample vial, thereby causing the pressure in the sample vial headspace to decrease below the vapor pressure at the surface of the liquid or aqueous sample 340, which can increase the net diffusion rates through the headspace during extraction to allow chemicals leaving the liquid surface to more quickly collect on the sorbent in the sorbent container 200. As the sample 340 boils, one or more compounds of the sample can enter the headspace of the sample vial. In some examples, the heating and/or cooling element(s) 312, and, therefore, the sample 340, can be at a low temperature when the vacuum is pulled either by actively cooling with a cooling element or by deactivating a heating element. Before the sample 340 is heated as decribed below, the vacuum source can be removed from the sorbent container 200 and the inside of the sample vials 330 can remain under vacuum.

Eventually, as more compounds of the sample 340 enters the headspace of the sample vial 330, the boiling of the sample can slow down or stop, for example. At this time, the sample 340 can be heated by activing a heating device or deactivating an active cooling device (e.g., of the one or more active heating and cooling element(s) 312). During this time, the convection fan 350 can regulate the temperature of the headspace of the sample vials 330 such that the headspace of the sample vials is at a lower temperature than the temperature of the sample 340. Heating the sample 340 in this way can cause the sample to continue to boil. When one or more compounds of the sample 340 enter the headspace of the sample vials 330, some of these compounds can become trapped within a sorbent of the sorbent container 200. In some examples, the sorbent containers 200 can include a sheath around the sorbent, with an opening at the bottom extraction end 212 of the sorbent container, thereby allowing compounds to be trapped at the extraction end 212 of the sorbent container (e.g., rather than deeper in the sorbent in the sorbent containers 200). In this way, compounds can be more likely to be successfully desorbed during chemical analysis, thereby cleaning the sorbent and preventing contamination of the sorbent across multiple uses.

During the heating process, net flow of chemicals from the liquid sample 340 to the gas phase can occur as the liquid vapor pressure continues to increase due to the heating, and the headspace can continue to pressurize with more matrix (e.g., including water and/or ethanol present in the sample). In this way, the evaporating compounds in the sample 340 can create a “carrier gas” to transfer one or more less volatile compounds into the headspace of the sample vial 330 that may not have otherwise entered the gas phase, for example. Without this positive flow of mass from the liquid surface into the gas phase, in some situations, some compounds, such as chemicals having low volatility or chemicals that have a high affinity to the liquid matrix, could be deflected back into the liquid sample 340, substantially decreasing their rate of transfer to the sorbent. In some examples, the system 300 can be gradually heated (e.g., at a rate in the range of 2-10 degrees Celsius per minute) to control the flow rate of the carrier gas within the closed system of the sample vial 330. By controlling the rate of boiling and therefore the rate of carrier gas formation, the production of aerosols can be reduced or minimized (e.g., nearly or substantially eliminated), which in turn reduces or minimizes the transfer of any non-volatile compounds into the gas phase, thereby avoiding the capture of non-volatile compounds in the sorbent of the sorbent container 200. While the sample 340 is being heated (e.g., by activating a heating element 312 or deactivating a cooling element 312), the convection oven can control the temperature of the headspace of the sample vials 330 such that it is at a lower temperature than the sample 340, which can continue the carrier gas process in the closed system of the sample vial 330.

The system 300 can maintain the warm temperature of the sample 340 for a predetermined period of time (e.g., 5 minutes or as much as one to two hours). During this time, the temperature of the sample vial 330 can be 10 to 50 degrees Celsius lower than the sample 340, for example. As the sample 340 continues to boil, the pressure of the headspace of the sample vials 330 can increase to the point where condensation of the matrix can occur on the vial 330 or on the sorbent container 200. The transfer of matrix can be allowed to occur long enough in some causes to completely transfer and condense the volatile liquid matrix to the cooler zone above (e.g., the headspace of the sample vials 330), thereby enhancing the transfer of low volatility compounds to the headspace of the sample vials.

At this time, the sample 340 can be cooled by activating a cooling element 312 or deactivating a heating element 312 and, in some examples, activating fans 314 (e.g., to cool the heating element). In some examples, the sample 340 can be cooled at a faster rate than the rate of heating (e.g., at a rate in the range of 4-20 degrees Celsius per minute). While the sample 340 is being cooled, the convection fan 350 can regulate the temperature of the headspace of the sample vials 330 to be at a temperature higher than the temperature of the sample 340, for example. In some examples, the convection fan 350 maintains a stable temperature of the headspace of the sample vials 330 during heating and cooling of the sample 340. In some examples, the convection fan 350 fluctuates the temperature of the headspace of the sample vials 330 when the sample 340 is being heated and cooled. That is to say, the convection fan 350 either causes the temperature of the headspace of the sample vials 330 to heat and cool at the same time as, but to a lesser extent than, the sample 340 (e.g., cooling the headspace of the sample vial while the liquid sample is being cooled, but to a less cold temperature) or causes the sample vials to heat and cool inverse from the liquid sample (e.g., heating the headspace of the sample vial while the liquid sample is being cooled).

Cooling the sample 340 in this way can cause one or more sample compounds and/or one or more matrix compounds in the headspace of the sample vials 330 or condensed on a surface within the sample vials to condense back into the sample 340. Cooling the sample 340 in the sample vial 330 to a lower temperature than the headspace of the sample vial can facilitate the condensation of the sample compounds from the headspace of the sample vial back into the liquid sample. During this recondensation of the volatile matrix back to sample 340, some compounds of interest that condensed with the matrix onto the vial 330 can be transferred back into the gas phase for another opportunity to be collected by sorbent 202 in sorbent container 200 (e.g., during the next heating phase). Further, in some examples, one or more volatile condensed matrix compounds, such as water and ethanol, within the sorbent container 200 can return to the liquid sample 340 during the cooling stage(s). This process of condensation, re-evaporation, and recondensation back into sample 340 can occur more rapidly under vacuum conditions where the net transfer rate of molecules can be increased by lowering the number of gas phase collisions. After the sample 340 reaches its minimum temperature, it can be heated again to further extract the sample 340 as described above, and then cooled again as described above, and so on. After multiple extractions, the final cooling stage may have a longer duration than the other cooling stages, which can further dehydrate the sorbent prior to chemical analysis to reduce matrix interferences. In some examples, the heating and cooling stages can be repeated a predetermined number of times (e.g., 2 to 20 cycles), for a predetermined duration of time (e.g., 30 minutes to 48 hours), which can generally be determined by experimentation using normal method development procedures where an acceptable recovery of spiked surrogate compounds or target compounds themselves through matrix addition techniques normally employed by chemical analysis methods is determined. The number of times the heating and cooling stages are repeated can depend on the volume of the sample, the volatility of the target compounds in the sample, the sorbent being used in the sorbent container, the temperatures used during extraction, the affinity of the compounds of interest to the matrix, the level of vacuum achieved, and other factors.

During extraction, the sample 340 can be repeatedly heated and cooled by the heating and/or cooling element(s) 312 as described above. When the sample 340 is heated, one or more sample compounds can enter the headspace of the sample vials 330 as individual gas phase molecules, for example, allowing some of these compounds to be trapped in the sorbent containers 200. When the sample 340 is cooled, compounds that entered the headspace of the sample vials 330 but did not enter the sorbent containers 200 can be transferred back into the gas phase for another chance to be trapped in the sorbent container 200, or can recondense with the volatile matrix back into sample 340 so they can again be carried into the headspace by the next heating of sample 340. In this way, the sample 340 can be boiled multiple times, allowing for increased concentration in the sorbent container 200. In some examples, one or more “non-volatile” compounds (e.g., lipids, proteins, biologicals, particulates, non-soluble materials, and most ionized species) can remain in the sample 340 in the sample vials 330 after extraction, reducing interference to the chemical analysis process that these one or more compounds may cause. The operation of the system 300 will now be described in more detail with reference to FIG. 4.

FIG. 4 illustrates an exemplary process 400 for extracting a sample for analysis according to examples of the disclosure. In some examples, process 400 can be performed by a system that is the same as or similar to system 300 described above with reference to FIGS. 3A and 3B.

In step 402, a vacuum can be drawn in the sample vials 330, for example. In some cases, the vacuum can be drawn in each sample vial 330 one at a time. In some examples, drawing the vacuum can cause the liquid or aqueous sample 340 to begin to boil. While the vacuum is being drawn, the sample 340 can be at a minimum temperature by deactivating a heating element included in the system or by activating a cooling element included in the system (e.g., heating and/or cooling element(s) 312). In some examples, drawing the vacuum can decrease the pressure of the headspace gas in the sample vials 330 to about 0.01-0.03 atmospheres. The vacuum source can be coupled to the sample vials 330 for a period of time in the range of 15-30 seconds or more, depending on a number of factors including the volume of the sample vial, the volume of the sample, the starting temperature of the system 300, and other factors. Before heating the sample 340, as will be described below, the vacuum source can be removed from the sorbent container 200 and sample vial.

In step 403, the convection oven 310 can be heated to an intermediate temperature that is between the high temperature applied to the sample 340 during the warming phase and the low temperature that is applied to the sample 340 during the cooling phase. The convection fan 350 and its included heating element can be used to apply the intermediate temperature to the headspace of the sample vials 330. Applying the intermediate temperature to the headspace of the sample vials 330 can create a temperature differential between the sample 340 and the headspace of the sample vials 330 to facilitate evaporation and condensation of the sample during the extraction process, as will be described below. In some examples, the intermediate temperature of the headspace of the sample vials 330 can remain constant during the extraction process. In some examples, the intermediate temperature can fluctuate.

In step 404, a temperature-pulsed zone (e.g., a lower part of the sample vial 330 including the sample 340) can be heated to a high temperature (e.g., by activating an active heating element 312 or by deactivating an active cooling element 312). In some examples, heating can take place over a duration of time on the order of 5 to 60 minutes or, in some cases, one to two hours. When the sample 340 is heated, the temperature of the headspace of the sample vials 330 can be at a lower temperature maintained by the convection fan 350, for example. In some examples, the convection fan 350 maintains a stable temperature of the headspace of the sample vials while the sample 340 is being heated and cooled (e.g., the temperature of the headspace of the sample vials remains constant during the extraction process, or only fluctuates with 1-5 degrees Celsius). In some examples, the convection fan 350 controls a fluctuation of the temperature of the headspace of the sample vials 330 during the heating and cooling process. In some examples, the headspace of the sample vials 330 can be heated when the sample 340 is heated, only to a lesser extent (i.e., during the heating stage 404, the headspace of the sample vials is heated relative to the temperature of the headspace of the sample vials while the liquid sample is being cooled). In some examples, the headspace of the sample vials 330 can be cooled when the sample 340 is heated (i.e., the temperature of the headspace of the sample vials when the sample is heated is less than the temperature of the headspace of the sample vials when the sample is cooled).

In some examples, heating the sample 340 to a temperature higher than the headspace of the sample vials 330 can create a carrier gas effect as one or more compounds of the sample evaporate. That is to say, the mass transfer of one or more compounds from the liquid phase to the gas phase can cause one or more other compounds (e.g., heavy compounds, compounds with a boiling point above the maximum temperature of the sample vial, low-volatility compounds, polar compounds, etc.) to enter the gas phase that may not have otherwise evaporated at the pressure and temperature of the sample vial 330. Sample compounds can enter the headspace of the sample vials 330 in the gas phase, for example. In some examples, one or more sample compounds that enter the headspace of the sample vials 330 can be trapped by a sorbent included in sorbent container 200.

In step 406, the temperature-pulsed zone (e.g., a lower part of the sample vial 330 including the sample 340) can be cooled to a low temperature (e.g., by activating an active cooling device 312 or deactivating an active heating device 312). In some examples, cooling can take place over a duration of time on the order of 5 minutes to as long as one to two hours. In some examples, cooling 406 the sample 340 can take less time than heating 404 the liquid sample. When the sample 340 is cooled, the temperature of the headspace of the sample vials 330 can be at a higher temperature maintained by the convection fan 350, for example. In some examples, the convection fan 350 maintains a stable temperature of the headspace of the sample vials while the sample 340 is being heated and cooled (e.g., the temperature of the headspace of the sample vials remains constant during the extraction process, or only fluctuates with 1-5 degrees Celsius). In some examples, the convection fan 350 controls a fluctuation of the temperature of the headspace of the sample vials 330 during the heating and cooling process. In some examples, the headspace of the sample vials 330 can be cooled when the sample 340 is cooled, to a lesser extent (i.e., during the cooling stage 406, the headspace of the sample vials is cooled relative to the temperature of the headspace of the sample vials while the liquid sample is being heated). In some examples, the headspace of the sample vials 330 can be heated when the sample 340 is cooled (i.e., the temperature of the headspace of the sample vials when the liquid sample is cooled is greater than the temperature of the headspace of the sample vials when the liquid sample is heated). In some examples, cooling the sample 340 can cause one or more sample compounds in the headspace of the sample vials 330 or condensed on a surface within the sample vial (e.g., the inner surface of the sample vial itself or the outer surface of the sorbent container) to condense into the liquid sample 340.

If extraction is not complete, steps 404 and 406 can be repeated as many times as needed (e.g., “no” at 408). In some examples, steps 404 and 406 are executed 2 to 20 times over the course of 30 minutes to 48 hours. In this way, one or more compounds that condensed back into the liquid sample 340 at step 406 can re-enter the headspace of the sample vial 330 and possibly be captured by the sorbent container 200 when step 404 is repeated.

If extraction is complete, step 410 of process 400 can be performed (e.g., “yes” at 408). In some examples, after steps 404 and 406 have been repeated, the sample 340 can enter a final cooling stage having a longer duration than previous cooling stages 406. For example, the final cooling stage can last for a duration of time in the range of 10-30 minutes up to two hours or more. In some examples, the duration of the final cooling stage can be determined experimentally where the volatile matrix was effectively transferred back to the bottom of the vial and out the sorbent container 200. During the final cooling stage, the sorbent container 200 can be dehydrated to reduce or prevent the injection of water or ethanol into the chemical analysis device. In some examples, during the final cooling stage 410, the sample 340 can be cooled to a temperature the same as or different from the low temperature they were exposed to in the other cooling stages (e.g., in step 406).

In some examples, the high and low temperatures of the sample 340 and the temperature(s) of the sample vial 330 headspace can be selected depending on the compounds to be analyzed. For example, non-heat sensitive samples such as water and others can be heated to a high temperature in the range of 40 to 100 degrees Celsius (e.g., 40, 70, or 100 degrees Celsius) and cooled to a low temperature in the range of 4 to 30 degrees Celsius. For these samples, the temperature of the headspace of the sample vials 330 can be in the range of 25 to 80 degrees Celsius (e.g., can remain at 60 degrees Celsius, can fluctuate between 50 degrees Celsius and 70 degrees Celsius, can remain at 50 degrees Celsius, can remain at 25 degrees Celsius, can fluctuate between 40 degrees Celsius and 25 degrees Celsius) during extraction. As described above, the temperature of the headspace of the sample vials 330 can remain constant or relatively constant (e.g., with a deviation in temperature around 1-5 degrees Celsius). In some examples in which the high temperature is above room temperature (e.g., around 20-25 degrees Celsius), system 300 can include a heating element, such as a hot plate, for heating the liquid sample to the high temperature. System 300 can optionally further include a cooling element, such as a Peltier cooler, for actively cooling the liquid sample during the cooling cycles, for example. In some examples, the sample 340 can be passively cooled during the cooling cycles by deactivating the heating element, allowing the cooling element to be eliminated. Further, the air flow fans 314 can be activated to facilitate the cooling of the heating element to assist in passively cooling the sample 340.

Heat-sensitive samples, such as food and beverage products and others, can be heated to a high temperature on the order of 40 degrees Celsius and cooled to a low temperature on the order of 4 degrees Celsius. For these samples, the temperature of the headspace of the sample vials 330 can be in the range of 20-50 degrees Celsius (e.g., can remain at a temperature of 25 degrees Celsius or fluctuate between 40 and 25 degrees Celsius), or as high as 70 degrees Celsius during extraction. As described above, the temperature of the headspace of the sample vials 330 can remain constant or relatively constant (e.g., with a deviation in temperature around 1-5 degrees Celsius). In this way, the system 300 can avoid “cooking” the sample 340, which can cause one or more compounds to form artifacts not present in the original sample, which could thereby reduce the accuracy of the chemical analysis process. In some examples in which the low temperature is below room temperature (e.g., around 20-25 degrees Celsius), system 300 can include a cooling element, such as a Peltier cooler, for cooling the liquid sample to the low temperature. System 300 can optionally further include a heating element, such as a hot plate, for actively heating the liquid sample during the warming cycles, for example. In some examples, during condensation 406, the convection oven 310 can be heated to a temperature above the temperature of the sample 340, as the thermally labile sample may not be condensed on the vial 330 but can remain in the sample 340. Therefore, the convection oven 310 can be heated to a temperature in the range of 40 or 50 degrees Celsius while the sample 340 is cooled to the low temperature (e.g., 4 degrees Celsius).

Once extraction is complete, the sorbent container 200, with one or more target compounds trapped within the sorbent, can be transferred to a desorption device coupled to a chemical analysis device so that the target compounds can be analyzed. Desorption and analysis of the sample will now be described with reference to FIGS. 5A-5B.

FIG. 5A illustrates an exemplary chemical analysis device 560, an exemplary sorbent container 500, and detector 540 for conducting chemical analysis according to examples of the disclosure. In some examples, chemical analysis device 560 and detector 540 can correspond to a chromatograph configured to perform gas chromatography (GC), gas chromatography-mass spectrometry (GCMS), liquid chromatography (LC), liquid chromatography-mass spectrometry (LCMS) or some other form of chemical analysis, including other forms of chromatography (e.g., detector 540 can be a mass spectrometer for detecting samples passing through the chemical analysis device 560, such as a quadrupole mass spectrometer). In some examples, chemical analysis device 560 includes a thermal chamber (e.g., a temperature-controlled oven for a gas chromatograph). The system illustrated in FIG. 5A can further include one or more processors (e.g., controllers, microprocessors, computers, computer systems, etc.) (not shown) running software and/or instructions housed on a non-transitory computer-readable medium for controlling the operation of one or more components of the chemical analysis system. The sorbent container 500 can house a sample that was previously collected in a sample extraction process, as described above with reference to FIGS. 2-4, for example.

In some examples, the chemical analysis device 560 can desorb sample from the sorbent container 502 using a thermal desorber configuration that will now be described. Specifically, in some examples, the chemical analysis device 560 can include divert vent 556, pre-column 562, primary column 564, injector 566, pressure controller 568, thermal desorption device 501 into which sorbent container 500 can be inserted for desorbing sample into chemical analysis device 560, and a plurality of valves 572-576, 578. In some examples, injector 566 can be a capped-off GC injector.

The desorption device 501 can be made of stainless steel and can optionally be lined with ceramic, and can include a replaceable liner 554, heater 522, and heat sink 558. Heater 522 can be a coil heater or another heating element that can heat the desorption device 501 during a chemical analysis process to desorb the sample. The replaceable liner 554 can improve transfer of the sample from the sorbent container 502 to the pre-column 562 and primary column 564 of chemical analysis device 560 without (or with minimal) chemical reactions, for example. Further, liner 554 can include channel 152 to fluidly couple the sorbent container 500 to the chemical analysis device 560. In some examples, heat sink 558 can protect rubber seals 508 between the sorbent container 500 and the desorption device 501 from excessive heat exposure and/or chemical outgassing. As an example, the rubber seals 508 can be included in the sorbent container 500 (as described above, e.g. with reference to FIG. 2).

In some examples, during the chemical analysis process (e.g., GC or GCMS), the first valve 572 can control flow of a carrier fluid from pressure controller 568 through sorbent container 500 for transfer of sample from the sorbent container to the pre-column 562 and primary column 564. In some examples, the sorbent container 500 contains sorbent and carrier fluid can flow through the sorbent in the sorbent container and into pre-column 562. The first valve 572 can be fluidly coupled to the sorbent container 500 by way of solvent evacuation port 532 of the sorbent container 500, for example. Depending on the chemical analysis procedure and in the disclosed configuration, the carrier fluid can be a gas (e.g., for GC or GCMS), though it is understood that in some configurations, the carrier fluid can be a liquid (e.g., for LC or LCMS). The second valve 574 can control the flow of fluid around (e.g., bypassing) the sorbent container 500 and pre-column 562 into divert vent 556 during preheating, for example. In some examples, the third valve 576 can control flow of fluid (flowing into sorbent container 500 via the first valve 572) out through split control 524 to precisely and reproducibly reduce the amount of sample transferred to the pre-column 562 and primary column 564 and/or to increase sample injection rates into the chemical analysis device 560. In some examples, the combination of the second valve 574 and the third valve 576 can backflush the pre-column 562 to prevent contamination of the primary column 564 with heavier contaminants, for example. The fourth valve 578 can control flow of fluid out from a divert vent 556 downstream of the pre-column 562 for performing high flow pre-column enrichment without splitting.

Upon desorption of the sample, the sample can pass from the sorbent container 500 through the pre-column 562 and the primary column 564 at a rate controlled by controller 568 by way of controlling the pressure of the carrier gas and by controlling the temperatures and temperature ramp rates of the analyzer 560. As the sample flows through the pre-column 562 and primary column 564, various compounds of the sample can move at different rates depending on compound mass, for example. In some examples, the sample can exit primary column 564 to enter the detector device 540, which can be used to identify the relative concentrations of compounds present in the sample based on time of arrival at the detector device 540 and by the mass fragmentation pattern of the compounds when using a mass spectrometer. In this way, the composition of the sample can be determined. Additionally or alternatively in some examples, the speed at which each compound travels through the pre-column 562 and the primary column 564 can be affected by one or more characteristics other than mass that determine the affinity of the compound to the columns 562 and 564.

FIG. 5B illustrates an exemplary process 180 for performing a chemical analysis procedure using sorbent container 500, desorption device 501, chemical analysis device 560, and detector device 540 according to examples of the disclosure. As an example, the chemical analysis process can be GCMS. To perform GCMS, the pressure controller 568 can supply a carrier gas, such as helium, nitrogen, or some other inert or non-reactive gas, which can flow through the sorbent inside sorbent container 500 (if any) and into pre-column 562 to facilitate sample desorption from the sorbent.

Initially, in step 582, the second valve 574 can be open, for example. In some examples, the sorbent container 500 can be inserted into the desorption device 501 in step 584 while second valve 574 is open. Next, in step 586, a pre-heat can occur while second valve 574 is open. In some examples, the pre-heat can take zero to three minutes, though other lengths of time are possible. After the pre-heat, the second valve 574 can be closed in step 588 and the first valve 572, which can be fluidly coupled to the sorbent container 500 by way of port 532 of the sorbent container 500, can be opened in step 590. The closing of second valve 574 and the opening of first valve 572 can cause the desorption of the sample in step 592, for example. For example, desorption of the sample may include desorbing the sample from the sorbent in sorbent container 500 and delivering the sample through the sample delivery port on the sorbent container into a column (e.g., precolumn) of the chemical analysis device 560. In some examples, at step 594, the third valve 576 can be opened to optionally perform a split injection. Performing a split injection can precisely and reproducibly reduce the amount of sample transferred to the column and increase injection rates, for example. In some examples, the third valve 576 can be closed and the fourth valve 578 can be opened in step 596 to improve transfer of heavy sample chemicals to the pre-column 562 while excess gas flows out from the fourth valve 578. Alternatively, in some examples, the third valve 576 can be left closed during sample desorption steps 592-596 to achieve complete transfer of heavy compounds into the pre-column 562. After desorption, if the fourth valve 578 had been opened in step 596, it can be closed in step 598, for example. The third valve 576 can open or remain open to remove any residual sample left in the sorbent container 500 during a bake out process to clean the sorbent container 500 for reuse in another sample analysis. In some examples, sorbent container 500 can be reused hundreds of times in this way. A more detailed discussion of the desorption device and its use can be found in U.S. patent application Ser. No. 15/954,504 entitled “THERMAL DESORBER FOR GAS CHROMATOGRAPHY SAMPLE INTRODUCTION WITH IMPROVED COMPOUND RECOVERY AND ENHANCED MATRIX MANAGEMENT” incorporated in its entirety herein for all purposes.

Therefore, according to the above, some examples of the disclosure are directed to a sample extraction system for preparing a sample for chemical analysis, the system comprising: a sample vial; a sorbent container configured to collect, for subsequent chemical analysis, one or more compounds from sample in the sample vial; and one or more temperature control elements configured to, while the sorbent container is positioned to collect the one or more compounds from the sample in the sample vial: heat the sample to a temperature; cool the sample to a temperature lower than the temperature to which the sample was heated; and repeat the heating of the sample and the cooling of the sample. Additionally or alternatively, in some examples the sample extraction system further comprises a convection oven, the convection oven coupled to the one or more temperature control elements, wherein: the sample vial is placed in the convection oven prior to heating and cooling the sample; while heating the sample, at least part of the sample is heated to a temperature higher than a temperature of a headspace of the sample vial; and while cooling the sample, at least part of the sample is cooled to a temperature lower than a temperature of the headspace of the sample vial. Additionally or alternatively, in some examples before heating and cooling the sample vial, a vacuum is drawn through the sorbent container to remove one or more fixed gasses of the sample vial, the fixed gasses including air. Additionally or alternatively, in some examples the one or more temperature control elements cool the sample to the temperature lower than the temperature to which the sample was heated and repeat the cooling of the sample for durations of time that are less than a first duration of time, and after repeating the heating of the sample and the cooling of the sample, the one or more temperature control elements continue to cool the sample vial for a duration of time greater than or equal to the first duration of time to further reduce one or more volatile matrix compounds in the sorbent container before performing a chemical analysis process. Additionally or alternatively, in some examples after repeating the heating of the sample and the cooling of the sample: the sorbent container is decoupled from the sample vial; the sorbent container is coupled to a chemical analysis device; and the chemical analysis device performs chemical analysis on the sample. Additionally or alternatively, in some examples the sample extraction system further comprises a sorbent retained by the sorbent container, the sorbent container having a body structure for retaining the sorbent and an open extraction end exposing part of the sorbent to a headspace of the sample vial without touching a liquid phase of the sample. Additionally or alternatively, in some examples while the sample is heated, one or more sample compounds are transferred from the sample to a headspace of the sample vial and into the sorbent retained by the sorbent container. Additionally or alternatively, in some examples the temperature to which the sample is heated is high enough to transfer one or more compounds of the sample into the headspace of the sample vial. Additionally or alternatively, in some examples while the sample is cooled, one or more sample gas or condensed phase matrix compounds located in a headspace of the sample vial condense into the sample. Additionally or alternatively, in some examples the sample includes one or more of a semi-volatile compound and a volatile compound, the sample includes one or more non-volatile compounds, and while the sample is heated: the one or more of the semi-volatile compound and the volatile compound transfer from a liquid phase of the sample to a headspace of the sample vial, and the one or more non-volatile compounds remain in the sample without transferring to the headspace of the sample vial.

Some examples of the disclosure are directed to a method comprising, while a sorbent container is positioned to collect, for subsequent chemical analysis, one or more compounds from sample in a sample vial: heating, with one or more temperature control elements, the sample to a temperature; cooling, with the one or more temperature control elements, the sample to a temperature lower than the temperature to which the sample was heated; and repeating the heating of the sample and the cooling of the sample. Additionally or alternatively, in some examples the method further comprises placing the sample vial in a convection oven prior to heating the sample and cooling the sample, the convection oven coupled to the one or more temperature control elements, wherein: while heating the sample to the first temperature, at least part of the sample is heated to a temperature higher than a temperature of a headspace of the sample vial; and while cooling the sample, at least part of the sample is cooled to a temperature lower than a temperature of the headspace of the sample vial. Additionally or alternatively, in some examples the method further comprises heating the sample and cooling the sample, drawing a vacuum through the sorbent container to remove one or more headspace gasses of the sample vial. Additionally or alternatively, in some examples the one or more temperature control elements cool the sample to the temperature lower than the temperature to which the sample was heated and repeat the cooling of the sample for durations of time that are less than a first duration of time, and after repeating the heating of the sample and the cooling of the sample, the one or more temperature control elements continue to cool the sample vial for a duration of time greater than or equal to the first duration of time to further reduce one or more volatile matrix compounds in the sorbent container before performing a chemical analysis process. Additionally or alternatively, in some examples the method further comprises after repeating the heating of the sample and the cooling of the sample: decoupling the sorbent container from the sample vial; coupling the sorbent container to a chemical analysis device; and performing chemical analysis on the sample. Additionally or alternatively, in some examples the sorbent container includes a body structure for retaining a sorbent and an open extraction end exposing part of the sorbent to a headspace of the sample vial without touching a liquid phase of the sample. Additionally or alternatively, in some examples while the sample is heated, one or more sample compounds are transferred from the sample to a headspace of the sample vial and into the sorbent retained by the sorbent container. Additionally or alternatively, in some examples the temperature to which the sample is heated is high enough to transfer one or more compounds of the sample into the headspace of the sample vial. Additionally or alternatively, in some examples while the sample is cooled, one or more gas or condensed phase sample matrix compounds located in a headspace of the sample vial condense into the sample. Additionally or alternatively, in some examples the sample includes one or more of a semi-volatile compound and a volatile compound, the sample includes one or more non-volatile compounds, and while the sample is heated: the one or more of the semi-volatile compound and the volatile compound transfer from a liquid phase of the sample to a headspace of the sample vial, and the one or more non-volatile compounds remain in the sample without transferring to the headspace of the sample vial.

Some examples of the disclosure are directed to a non-transitory computer-readable medium storing instructions that, when executed by one or more processors operatively coupled to a sample extraction system, cause the processors to perform a method comprising: while a sorbent container is positioned to collect, for subsequent chemical analysis, one or more compounds from sample in a sample vial: heating, with one or more temperature control elements, the sample to a temperature; cooling, with the one or more temperature control elements, the sample to a temperature lower than the temperature to which the sample was heated; and repeating the heating of the sample and the cooling of the sample.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A sample extraction system for preparing a sample for chemical analysis, the system comprising:
a sample vial;
a sorbent container configured to collect, for subsequent chemical analysis, one or more compounds from sample in the sample vial; and
one or more temperature control elements configured to, while the sorbent container is positioned to collect the one or more compounds from the sample in the sample vial:
heat the sample to a temperature;
cool the sample to a temperature lower than the temperature to which the sample was heated; and
repeat the heating of the sample and the cooling of the sample.

2. The sample extraction system of claim 1, further comprising:
a convection oven, the convection oven coupled to the one or more temperature control elements, wherein:
the sample vial is placed in the convection oven prior to heating and cooling the sample;
while heating the sample, at least part of the sample is heated to a temperature higher than a temperature of a headspace of the sample vial; and
while cooling the sample, at least part of the sample is cooled to a temperature lower than a temperature of the headspace of the sample vial.

3. The sample extraction system of claim 1, wherein:
before heating and cooling the sample vial, a vacuum is drawn through the sorbent container to remove one or more fixed gasses of the sample vial, the fixed gasses including air.

4. The sample extraction system of claim 1, wherein:
the one or more temperature control elements cool the sample to the temperature lower than the temperature to which the sample was heated and repeat the cooling of the sample for durations of time that are less than a first duration of time, and
after repeating the heating of the sample and the cooling of the sample, the one or more temperature control elements continue to cool the sample vial for a duration of time greater than or equal to the first duration of time to further reduce one or more volatile matrix compounds in the sorbent container before performing a chemical analysis process.

5. The sample extraction system of claim 1, wherein:
after repeating the heating of the sample and the cooling of the sample:
the sorbent container is decoupled from the sample vial;
the sorbent container is coupled to a chemical analysis device; and
the chemical analysis device performs chemical analysis on the sample.

6. The sample extraction system of claim 1, further comprising:
a sorbent retained by the sorbent container, the sorbent container having a body structure for retaining the sorbent and an open extraction end exposing part of the sorbent to a headspace of the sample vial without touching a liquid phase of the sample.

7. The sample extraction system of claim 6, wherein:
while the sample is heated, one or more sample compounds are transferred from the sample to a headspace of the sample vial and into the sorbent retained by the sorbent container.

8. The sample extraction system of claim 7, wherein the temperature to which the sample is heated is high enough to transfer one or more compounds of the sample into the headspace of the sample vial.

9. The sample extraction system of claim 1, wherein:
while the sample is cooled, one or more sample gas or condensed phase matrix compounds located in a headspace of the sample vial condense into the sample.

10. The sample extraction system of claim 1, wherein:
the sample includes one or more of a semi-volatile compound and a volatile compound,
the sample includes one or more non-volatile compounds, and
while the sample is heated:
the one or more of the semi-volatile compound and the volatile compound transfer from a liquid phase of the sample to a headspace of the sample vial, and
the one or more non-volatile compounds remain in the sample without transferring to the headspace of the sample vial.

11. A method comprising:
while a sorbent container is positioned to collect, for subsequent chemical analysis, one or more compounds from sample in a sample vial:
heating, with one or more temperature control elements, the sample to a temperature;
cooling, with the one or more temperature control elements, the sample to a temperature lower than the temperature to which the sample was heated; and
repeating the heating of the sample and the cooling of the sample.

12. The method of claim 11, further comprising:
placing the sample vial in a convection oven prior to heating the sample and cooling the sample, the convection oven coupled to the one or more temperature control elements, wherein:
while heating the sample to the first temperature, at least part of the sample is heated to a temperature higher than a temperature of a headspace of the sample vial; and
while cooling the sample, at least part of the sample is cooled to a temperature lower than a temperature of the headspace of the sample vial.

13. The method of claim 11, further comprising:
heating the sample and cooling the sample, drawing a vacuum through the sorbent container to remove one or more headspace gasses of the sample vial.

14. The method of claim 11, wherein:
the one or more temperature control elements cool the sample to the temperature lower than the temperature to which the sample was heated and repeat the cooling of the sample for durations of time that are less than a first duration of time, and
after repeating the heating of the sample and the cooling of the sample, the one or more temperature control elements continue to cool the sample vial for a duration of time greater than or equal to the first duration of time to further reduce one or more volatile matrix compounds in the sorbent container before performing a chemical analysis process.

15. The method of claim 11, further comprising:
after repeating the heating of the sample and the cooling of the sample:
decoupling the sorbent container from the sample vial;
coupling the sorbent container to a chemical analysis device; and
performing chemical analysis on the sample.

16. The method of claim 11, wherein the sorbent container includes a body structure for retaining a sorbent and an open extraction end exposing part of the sorbent to a headspace of the sample vial without touching a liquid phase of the sample.

17. The method of claim 16, wherein:
while the sample is heated, one or more sample compounds are transferred from the sample to a headspace of the sample vial and into the sorbent retained by the sorbent container.

18. The method of claim 17, wherein the temperature to which the sample is heated is high enough to transfer one or more compounds of the sample into the headspace of the sample vial.

19. The method of claim 11, wherein:
while the sample is cooled, one or more gas or condensed phase sample matrix compounds located in a headspace of the sample vial condense into the sample.

20. The method of claim 1, wherein:
the sample includes one or more of a semi-volatile compound and a volatile compound,
the sample includes one or more non-volatile compounds, and
while the sample is heated:
the one or more of the semi-volatile compound and the volatile compound transfer from a liquid phase of the sample to a headspace of the sample vial, and
the one or more non-volatile compounds remain in the sample without transferring to the headspace of the sample vial.

21. A non-transitory computer-readable medium storing instructions that, when executed by one or more processors operatively coupled to a sample extraction system, cause the processors to perform a method comprising:
while a sorbent container is positioned to collect, for subsequent chemical analysis, one or more compounds from sample in a sample vial:
heating, with one or more temperature control elements, the sample to a temperature;
cooling, with the one or more temperature control elements, the sample to a temperature lower than the temperature to which the sample was heated; and
repeating the heating of the sample and the cooling of the sample.
